(19) United States
(12) Patent Application Publication
(10) Pub. No.: US 2013/0017861 A1
(43) Pub. Date: Jan. 17, 2013

(54) ANTENNA DEVICE FOR A PORTABLE TERMINAL

(71) Applicant: Tae-Wook KWON, Gyeonggi-do (KR)

(72) Inventor: Tae-Wook KWON, Gyeonggi-do (KR)

(73) Assignee: SAMSUNG ELECTRONICS CO., LTD., Gyeonggi-Do (KR)

(21) Appl. No.: 13/298,616

(22) Filed: Nov. 17, 2011

(30) Foreign Application Priority Data
Jul. 13, 2011 (KR) 10-2011-0069657

(51) Int. Cl. H04W 88/02

(52) U.S. Cl. 455/557

(57) ABSTRACT

An antenna device for a portable terminal is provided, in which a main circuit board has a contact terminal on one surface of the main circuit board, and a Printed Circuit Board (PCB) has an ear jack socket installed on one surface of the PCB. At least a part of the PCB faces the main circuit board and a grounding signal line of the ear jack socket is connected to the contact terminal through the PCB.

### CLAIM OF PRIORITY

This application claims priority under 35 U.S.C. §119(a) to a Korean Patent Application filed in the Korean Intellectual Property Office on Jul. 13, 2011 and assigned Serial No. 10-2011-0069657, the contents of which are incorporated herein by reference.

### BACKGROUND OF THE INVENTION

1. Field of the Invention

The present invention relates to a portable terminal, and more particularly, to an antenna device for a portable terminal.

2. Description of the Related Art

A portable terminal is capable of a communication function such as voice call or short message transmission, a data communication function such as Internet browsing, mobile banking, and multimedia file transmission, and an entertainment function such as gaming, music, and video playback.

In the past, a portable terminal is typically specialized in one of a communication function, a gaming function, a multimedia function, an electronic note function, etc. Now, owing to the development of electronic and electrical technology as well as communication technology, the above various functions can be performed with a single portable terminal.

As a portable terminal has been equipped with a Digital Multimedia Broadcasting (DMB) function, it needs a broadcasting antenna as well as an antenna device designed for communication. Broadcasting antennas are classified into an in-built antenna, an extendable antenna that is built in and extended from a terminal, and a detachable antenna that is installed at an antenna port.

In the case where a portable terminal has a built-in broadcasting antenna inside it, the transmission efficiency of a data transmission line is decreased because the power supply of the built-in broadcasting antenna is disposed in the vicinity of data the transmission line in the portable terminal.

Compared to a communication antenna that transmits or receives signals to or from a base station all the time or at least periodically, a broadcasting antenna does not need to be always connected to a transmission and reception circuit because the broadcasting function is activated only upon a user's request.

In addition, as continuous efforts are concentrated to manufacture small-size, lightweight portable terminals, a broadcasting antenna having the detachable configuration may be preferred to a built-in or extendable broadcasting antenna within a portable terminal.

However, the detachable broadcasting antenna protrudes outward from the portable terminal, which is rather inconvenient. Hence, a user must carry the detachable broadcasting antenna separately along with the portable terminal, in case for broadcasting reception. Moreover, as some users do carry other peripheral devices of the portable terminal such as an earphone, a hands-free kit, an extra battery, a discharger for travel, a stylus pen, etc., the additional detachable broadcasting antenna they must carry can cause more inconvenience.

### SUMMARY OF THE INVENTION

An aspect of embodiments of the present invention is to address at least the problems and/or disadvantages and to provide at least the advantages described below. Accordingly, an aspect of embodiments of the present invention is to provide an antenna device that enables a portable terminal having peripheral devices more portable by simplifying the configuration of the portable terminal.

Another aspect of embodiments of the present invention is to provide an antenna device that can increase the transmission efficiency of a transmission line within a portable terminal.

A further aspect of embodiments of the present invention is to provide an antenna device that enables broadcasting reception through a portable terminal by means of an earphone with a 3.5-mm jack.

In accordance with an embodiment of the present invention, there is provided an antenna device for a portable terminal, in which a main circuit board has a contact terminal on one surface of the main circuit board, and a Printed Circuit Board (PCB) has an ear jack socket installed on one surface of the PCB, wherein at least a part of the PCB faces the main circuit board and a grounding signal line of the ear jack socket is connected to the contact terminal through the PCB.

In accordance with an embodiment of the present invention, an antenna device for a portable terminal includes: a main circuit board having an opening; and a Printed Circuit Board (PCB) having an ear jack socket mounted thereon and provided in the opening of the main circuit board, the ear jack socket is adapted to receive an earphone so that a partial conductive line of the earphone serves as a broadcasting antenna for wireless signal transmission and reception, wherein the PCB is coupled to the main circuit board via a contact terminal and a grounding signal line of the ear jack socket is in contact with the contact terminal.

In accordance with an embodiment of the present invention, a portable terminal includes: a housing; and an ear jack socket provided within the housing to receive an earphone jack, wherein a grounding signal line of the ear jack socket is coupled to a transmission and reception circuit of the main circuit board when the earphone jack is inserted into the ear jack socket, so that a partial conductive line of an earphone inserted into the ear jack socket serves as an antenna radiator for the portable terminal for the transmission and reception of signals.

### BRIEF DESCRIPTION OF THE DRAWINGS

The above features and advantages of certain embodiments of the present invention will be more apparent from the following detailed description taken in conjunction with the accompanying drawings, in which:

FIG. 1 is an exploded perspective view of an important part of an antenna device according to an embodiment of the present invention;

FIG. 2 is a plan view of the antenna device illustrated in FIG. 1;

FIG. 3 is a side sectional view of an important part of a portable terminal having the antenna device illustrated in FIG. 1; and

FIG. 4 is schematic diagram of the antenna device illustrated in FIG. 1.

Throughout the drawings, the same drawing reference numerals will be understood to refer to the same elements, features and structures.

### DETAILED DESCRIPTION

Reference will now be made in detail to the preferred embodiments of the present invention with reference to the accompanying drawings. For the purposes of clarity and simplicity, a detailed description of a generally known function and structure of the present invention will be avoided as it may obscure the subject matter of the present invention.

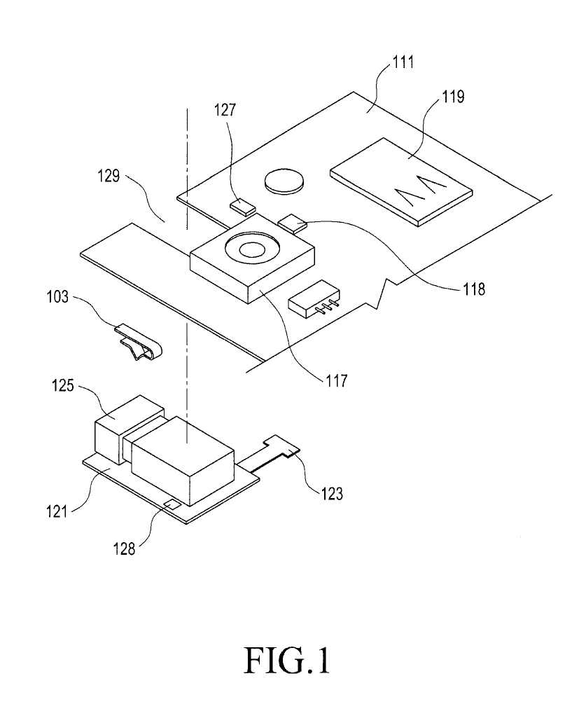

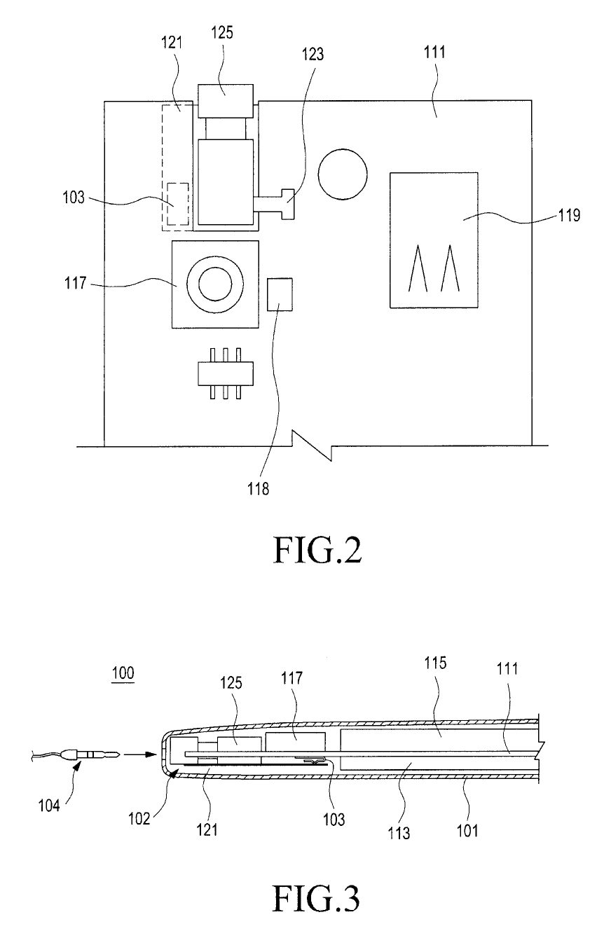

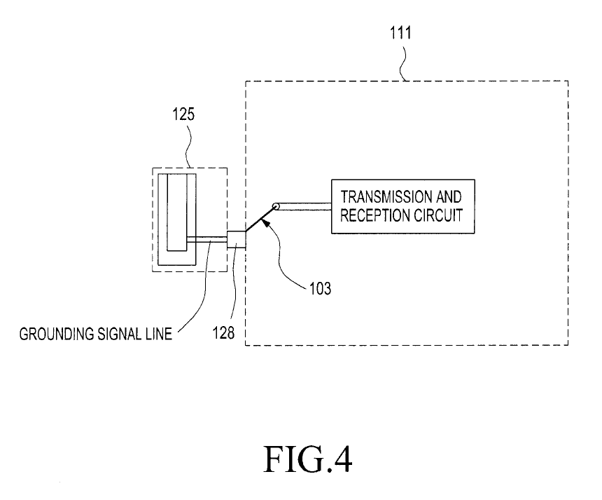

Referring to FIGS. 1, 2, 3 and 4, an antenna device for a portable terminal 100 according to an embodiment of the present invention uses an ear jack socket 125 and an earphone jack 104 inserted into the ear jack socket 125. More specifically, a grounding signal line of the ear jack socket 125 is connected to a transmission and reception circuit of a main circuit board 111. Thus, a partial conductive line of an earphone inserted into the ear jack socket 125 serves as an antenna radiator of the portable terminal 100, and wireless signal transmission and reception is enabled through the partial conductive line of the earphone. If the transmission and reception circuit on the main circuit board 111, to which the grounding signal line of the ear jack socket 125 is connected, is a terrestrial multimedia broadcasting reception circuit, the antenna device may be used to receive terrestrial multimedia broadcasting. In addition, the transmission and reception circuit of the main circuit board 111 may include an FM radio reception circuit.

The portable terminal 100 may use the earphone inserted into the ear jack socket 125 as a broadcasting antenna, which obviates the need for additionally using a detachable broadcasting antenna. As a consequence, the number of peripheral devices can be reduced for the portable terminal 100. In addition, the transmission efficiency of a transmission line can be increased by separating the transmission line from a power supply of the broadcasting antenna in the portable terminal 100. If the ear jack socket 125 is configured to be a typical earphone socket with a 3.5-pi ear jack, a user may use any of various commercially available earphones as the antenna device of the present invention.

The portable terminal 100 includes the main circuit board 111 on which a communication circuit, a memory chip, a control circuit, a storage medium socket 119, a camera device 117, a lighting 118 for taking a photo, etc. are mounted. An accommodation opening 129 is formed at an edge of one side of the main circuit board 111 for accommodating the ear jack socket 125. A connector 127 is provided on the main circuit board 111 at one side of the accommodation opening 129 for connecting to the ear jack socket 125.

A contact terminal 103 is disposed on one surface of the main circuit board 111, preferably on a frontal surface of the main circuit board 111 on which a display is mounted. The grounding signal line of the ear jack socket 125 is connected to the transmission and reception circuit of the main circuit board 111 via the contact terminal 103. The contact terminal 103 may be configured using a C-clip. When the antenna device is used as a broadcasting antenna, the contact terminal 103 may be connected to a reception end of the transmission and reception circuit.

The ear jack socket 125 is installed on an additional PCB 121. The PCB 121 is preferably a flexible PCB and has a connector terminal 123 extended from one side of the PCB 121. When the ear jack socket 125 is accommodated in the accommodation opening 129, the PCB 121 is positioned on one surface of the main circuit board 111, at least a part of the PCB 121 facing at least a part of the main circuit board 111. The connector terminal 123 is disposed on a rear surface of and connected to the connector 127 on the main circuit board 111.

A contact piece 128 is installed on one surface of the PCB 121 for being connected to the grounding signal line of the ear jack socket 125 via one of signal lines of the PCB 121. When the PCB 121 is mounted on the main circuit board 111, the ear jack socket 125 is connected to the transmission and reception circuit of the main circuit board 111 via the contact piece 128 and the contact terminal 103.

When the main circuit board 111 is accommodated within a housing 101 of the portable terminal 100, a battery pack 115 is positioned on a surface of the main circuit board 111 opposite to the surface of the main circuit board 111 on which the display 113 is mounted, that is, on the other surface of the main circuit board 111, and the ear jack socket 125 is positioned substantially in side by side with the battery pack 115. The camera device 117, etc. may be interposed between the ear jack socket 125 and the battery pack 115.

When the main circuit board 111 and the PCB 121 are arranged in the housing 101 of the portable terminal 100, various structures may be formed in the housing 101 in order to position and firmly fix the main circuit board 111 and the PCB 121.

As is apparent from the above description, an antenna device according to the present invention is configured using an earphone inserted into an ear jack socket, thereby simplifying the configuration of a portable terminal having peripheral devices. That is, since there is no need for carrying a detachable broadcasting antenna to receive DMB, user convenience is increased. What is better, it is not necessary to secure an additional accommodation space for the antenna device within the portable terminal and the ear jack socket into which an ear phone or a hands-free kit is inserted can be used as an antenna terminal. As a consequence, circuit configuration and arrangement are simplified in the portable terminal. That is, a portable terminal having the antenna device of the present invention does not need an additional terminal for installing a detachable broadcasting antenna. Therefore, the antenna device of the present invention can contribute to miniaturization of the portable terminal. In addition, because transmission lines connected to a power supply of the antenna device and a display, etc. can be distributed, their transmission efficiency can be increased.

While the present invention has been particularly shown and described with reference to embodiments thereof, it will be understood by those of ordinary skill in the art that various changes in form and details may be made therein without departing from the spirit and scope of the present invention as defined by the following claims.

What is claimed is:

1. An antenna device for a portable terminal, comprising:
a main circuit board having an opening and a contact terminal disposed at one end of the main circuit board; and
a Printed Circuit Board (PCB) having an ear jack socket mounted thereon,
wherein the PCB is housed in the opening of the main circuit board houses so that a grounding signal line of the ear jack socket is in contact with the contact terminal.

2. The antenna device of claim 1, further comprising a transmission and reception circuit provided on the main circuit board, wherein the contact terminal is coupled to a reception end of the transmission and reception circuit.

3. The antenna device of claim 2, wherein the transmission and reception circuit is a terrestrial multimedia broadcasting reception circuit.

4. The antenna device of claim 1, further comprising a display installed at the one end of the main circuit board adjacent to the contact terminal.

5. The antenna device of claim 4, further comprising a battery pack provided at other end of the main circuit board adjacent to the ear jack socket.

6. The antenna device of claim 4, further comprising a transmission and reception circuit provided on the one end of the main circuit board on which the display is installed, wherein the contact terminal is connected to a reception end of the transmission and reception circuit.

7. The antenna device of claim 4, wherein the ear jack socket is an earphone socket having a 3.5-pi jack.

8. The antenna device of claim 1, wherein the ear jack socket is an earphone socket having a 3.5-pi jack.

9. An antenna device for a portable terminal, comprising:
a main circuit board having an opening; and
a Printed Circuit Board (PCB) having an ear jack socket mounted thereon and provided in the opening of the main circuit board, the ear jack socket is adapted to receive an earphone so that a partial conductive line of the earphone serves as a broadcasting antenna for wireless signal transmission and reception,
wherein the PCB is coupled to the main circuit board via a contact terminal and a grounding signal line of the ear jack socket is in contact with the contact terminal.

10. The antenna device of claim 9, further comprising a transmission and reception circuit provided on the main circuit board, wherein the contact terminal is coupled to a reception end of the transmission and reception circuit.

11. The antenna device of claim 10, wherein the transmission and reception circuit is a terrestrial multimedia broadcasting reception circuit.

12. The antenna device of claim 9, further comprising a display installed at one end of the main circuit board adjacent to the contact terminal.

13. The antenna device of claim 12, further comprising a battery pack provided at other end of the main circuit board adjacent to the ear jack socket.

14. The antenna device of claim 12, further comprising a transmission and reception circuit provided on the one end of the main circuit board on which the display is installed, wherein the contact terminal is coupled to a reception end of the transmission and reception circuit.

15. The antenna device of claim 9, wherein the ear jack socket is an earphone socket having a 3.5-pi jack.

16. A portable terminal, comprising:
a housing; and
an ear jack socket provided within the housing to receive an earphone jack, wherein a grounding signal line of the ear jack socket is coupled to a transmission and reception circuit of the main circuit board when the earphone jack is inserted into the ear jack socket, so that a partial conductive line of an earphone inserted into the ear jack socket serves as an antenna radiator for the portable terminal for the transmission and reception of signals.

17. The portable terminal of claim 16, further comprising a transmission and reception circuit provided on the main circuit board, wherein the contact terminal is coupled to a reception end of the transmission and reception circuit.

18. The portable terminal of claim 17, wherein the transmission and reception circuit is a terrestrial multimedia broadcasting reception circuit.

19. The portable terminal of claim 16, wherein the ear jack socket is an earphone socket having a 3.5-pi jack.
